(19) United States
(12) Patent Application Publication
(10) Pub. No.: US 2003/0223706 A1
(43) Pub. Date: Dec. 4, 2003

(54) Electric apparatus

(76) Inventor: Yuan-Jen Chao, Kaohsiung (TW)

Correspondence Address: BIRCH STEWART KOLASCH & BIRCH, PO BOX 747, FALLS CHURCH, VA, 22040-0747, US

(21) Appl. No.: 10/428,922

(22) Filed: May 5, 2003

(30) Foreign Application Priority Data
May 31, 2002 (TW) 091111766

(51) Int. Cl. G02B 6/36

(52) U.S. Cl. 385/92

(57) ABSTRACT

An electric apparatus includes a casing, an emitting unit, and a receiving unit. In this case, the casing has an optical surface inside, and the emitting unit and the receiving unit are arranged in the casing. The emitting unit emits an optical modulation signal, and the receiving unit picks up the optical modulation signal, wherein the optical modulation signal travels through the optical surface.

### BACKGROUND OF THE INVENTION

1. Field of Invention

The invention relates to an electric apparatus and, in particular, to an electric apparatus having an optical surface for transmitting optical modulation signals.

2. Related Art

In general, an electric apparatus consists of one or more functional units. For an electric apparatus to operate successfully, each functional unit of the electric apparatus must cooperate with the other functional unit or units. Various signals are transmitted in between each functional unit so that the functional units are able to communicate and cooperate with each other. In the prior art, electrical signals are commonly used in communication and signal transmission, and the transmission medium of electrical signals is usually a metal conductor. For instance, the transmission medium of electrical signals used in a printed circuit board, or an electric cable is a copper line.

However, when using electrical signals to communicate between each functional unit, RC delay caused by electric resistance and capacitance of the transmission medium exists. Therefore, the transmission speed of electrical signals is restricted. Furthermore, the RC delay may cause signal phase delay, so that synchronous signal transmission fails when the frequency of the electrical signals is too high. In such cases, the electrical signals can only be transmitted by asynchronous transmission, and the transmission speed of electrical signals will be thus reduced.

In addition, the frequency of electrical signals must be increased for high-speed signal transmission. During transmission in the mentioned transmission medium, external noise may cause interference to the high-frequency electrical signals inducing errors or mistakes. The functional units of the electric apparatus may also be affected by the accompanying electromagnetic interference (EMI). Moreover, the development of semiconductor technology has resulted in the functional units becoming more compact, and the electrical signal used in the electric apparatus has become relatively weaker. External noise during transmission may more easily interfere the weak electrical signal, and may cause the apparatus to function abnormally.

To avoid the previously mentioned problems, people skilled in the art have replaced electrical signals with optical modulation signals. In such cases, the optical modulation signals are output from an emitting unit to a receiving unit via an optical fiber or optical fibers. After receiving the optical modulation signals, the receiving unit transforms the optical modulation signals to the original electrical signals. Therefore, the functional units can communicate and cooperate with each other, and the electric apparatus functions normally. Use of optical fibers for signal transmission has the advantages of wide bandwidth, no EMI and no noise interference, thus efficiently solves the previously mentioned problems.

It is difficult, however, to split or merge two or more optical fibers. Thus, the optical modulation signal is usually employed in a one-to-one transmission; that is, the optical modulation signal is transmitted from one node (emitting unit) to another corresponding node (receiving unit). In the conventional method, when one-to-many transmission is needed, a splitter or a demultiplexer is used for splitting an optical modulation signal into several optical modulation signals, each of which is respectively output to a corresponding optical fiber. Conversely, when many-to-one transmission is needed, a multiplexer or a combiner is used to combine optical modulation signals from different fibers into a single optical modulation signal, which is transmitted into a single fiber. The splitter, demultiplexer, combiner and multiplexer, however, make an electric apparatus more complicated, and also increase the cost thereof.

Additionally, it is common that the emitting unit is an LED or a laser diode, and the receiving unit is a PIN diode. Thus, a precision connector is required for connecting a fiber with the emitting unit or receiving unit. Accordingly, the manufacturing cost of the electric apparatus is further increased.

Since it is necessary to employ components such as a splitter, demultiplexer, combiner, multiplexer and connector for transmission of optical modulation signals in an electric apparatus, the manufacturing cost of the electric apparatus is increased. In addition, the splitter, demultiplexer, combiner, multiplexer and connector require a certain amount of space inside the electric apparatus. It may be practically difficult to put all these necessary components inside the electric apparatus that has a limited internal space. As mentioned above, it is an important objective of the invention to provide an electric apparatus with a simple, and efficient medium for transmission of optical modulation signals.

### SUMMARY OF THE INVENTION

In view of the previously mentioned problems, an objective of the invention is to provide an electric apparatus having a simple and efficient transmission medium for transmission of optical modulation signals.

To achieve the above-mentioned objective, the invention provides an electric apparatus including a casing, an emitting unit, and a receiving unit. In the invention, an optical surface is provided inside the casing, and the emitting unit and receiving unit are provided in the casing. The emitting unit emits an optical modulation signal, and the receiving unit receives the signal. Wherein, the optical modulation signal is output from the emitting unit, travels through the optical surface, and is input into the receiving unit.

In an aspect of the invention, the casing is filled with air, which is a transmission medium of the optical modulation signal. In an alternative aspect of the invention, a transparent bulk material is provided inside the casing, and is a transmission medium of the optical modulation signal.

As previously mentioned, the electric apparatus of the invention employs air or the transparent bulk material provided inside the casing as a transmission medium of the optical modulation signal. Therefore, the optical modulation signal can be transmitted from a single node to multiple nodes or from multiple nodes to a single node inside the electric apparatus of the invention without using the conventional fiber, splitter, demultiplexer, combiner and multiplexer. Moreover, the emitting unit and receiving unit can interface directly with the transmission medium, which is air or the transparent bulk material, so that the conventional connector is unnecessary. Thus, the manufacturing cost of the electric apparatus of the invention is further reduced.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram showing an electric apparatus according to a preferred embodiment of the invention;

FIG. 2 is a schematic diagram showing an electric apparatus including a plurality of emitting and receiving units according to another preferred embodiment of the invention; and

FIG. 3 is a schematic diagram showing an electric apparatus including a plurality of receiving units and IC chips according to yet another preferred embodiment of the invention.

### DETAILED DESCRIPTION OF THE INVENTION

The electric apparatus according to the preferred embodiments of the invention will be described hereinbelow with reference to the accompanying drawings, wherein the same reference numbers refer to the same elements.

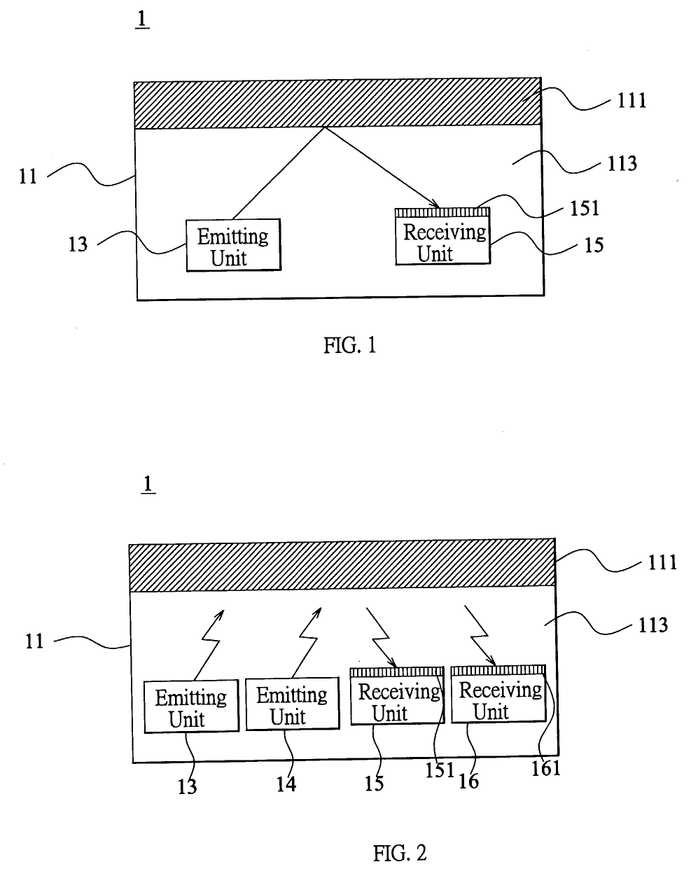

With reference to FIG. 1, an electric apparatus 1 according to a preferred embodiment of the invention includes a casing 11, an emitting unit 13 and a receiving unit 15.

The emitting unit 13 and receiving unit 15 are mounted inside the casing 11. In the invention, the emitting unit 13 emits an optical modulation signal, and the receiving unit 15 receives the optical modulation signal.

The casing 11 has an optical surface 111 and a transmission medium 113 inside. In the current embodiment, the optical surface 111 can be a reflecting surface, a scattering surface, or a refracting surface for reflecting, scattering or refracting the optical modulation signal emitted from the emitting unit 13 to the receiving unit 15. In this case, the optical surface 111 is mounted on the internal surface of the casing 11. Furthermore, the transmission medium 113 for transmitting the optical modulation signal can be a transparent bulk material or air contained in the casing 11.

As mentioned above, the electric apparatus 1 may further include a circuit substrate (not shown) provided in the casing 11, and the optical surface 111 can be set on the circuit substrate.

In the present embodiment, the emitting unit 13 is an LED or a laser diode, and the receiving unit 15 is a photo diode, such as a PIN diode, for receiving optical modulation signals. As shown in FIG. 1, the receiving unit 15 may further include an optical filter 151 for filtering the optical modulation signal to retrieve the signal of a specific-wavelength. In this case, the receiving unit 15 receives an optical modulation signal of a desired wavelength.

In addition, an electric apparatus according to another preferred embodiment of the invention may include a plurality of emitting units and receiving units. For instance, an electric apparatus 1 according to another preferred embodiment of the invention, referring to FIG. 2, includes a casing 11, an emitting unit 13, an emitting unit 14, a receiving unit 15, and a receiving unit 16.

In the current embodiment, the receiving units 15 and 16 respectively have optical filters 151 and 161. As previously mentioned, the optical filters 151 and 161 filter optical modulation signals output from the emitting units 13 and 14. In detail, the optical filter 151 filters the optical modulation signals output from the emitting units 13 and 14, so only the optical modulation signal of a specific-wavelength passes through the optical filter 151. Similarly, the optical filter 161 can filter the optical modulation signals output from the emitting units 13 and 14, and the optical modulation signal of another specific-wavelength can pass through the optical filter 161. Therefore, the electric apparatus 1 of the invention can transmit optical modulation signals from a single node to multiple nodes or from multiple nodes to a single node, and the splitter, demultiplexer, combiner and multiplexer are unnecessary.

In more detail, when the emitting units 13 and 14 respectively output optical modulation signals of the wavelengths in between 400 nm and 550 nm, the receiving units 15 and 16 simultaneously receive the optical modulation signals output from the emitting units 13 and 14. In this case, the optical filters 151 and 161 respectively retrieve specific-wavelength optical modulation signals of 450 nm and 500 nm, so the receiving unit 15 receives the specific-wavelength optical modulation signals of 450 nm output from the emitting units 13 and 14, and the receiving unit 16 receives the specific-wavelength optical modulation signals of 500 nm output from the emitting units 13 and 14. People skilled in the art should know that the electric apparatus of the previously mentioned embodiment is able to transmit optical modulation signals from a single node to multiple nodes or from multiple nodes to a single node without using the splitter, demultiplexer, combiner and multiplexer.

As another example, if the emitting unit 13 or 14 outputs an optical modulation signal of 450 nm, and the optical filters 151 and 161 retrieve the same 450 nm signal, then the receiving units 15 and 16 can simultaneously receive the same optical modulation signal output from the emitting unit 13 or 14. Thus the current embodiment is able to transmit optical modulation signals from a single node to multiple nodes without a splitter or a demultiplexer.

It should be noted that the mentioned emitting and receiving units might be signally connected to IC chips, respectively. The emitting and receiving units could also be parts of the IC chips. The present invention is described in greater detail with reference to the following embodiment.

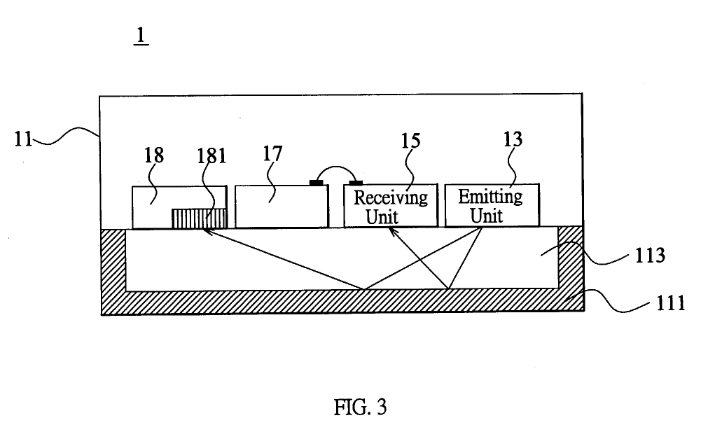

Please refer to FIG. 3. Another electric apparatus 1 according to yet another preferred embodiment of the invention includes a casing 11, an emitting unit 13, a receiving unit 15, an IC chip 17, a receiving unit 181, and an IC chip 18.

In this embodiment, the receiving unit 15 electrically connects to the IC chip 17. When the optical modulation signal output from the emitting unit 13 is reflected or scattered by the optical surface 111 and then arrives at the receiving unit 15, the receiving unit 15 receives the optical modulation signal and converts it into an electrical signal, which could be a digital signal or an analog signal. After that, the receiving unit 15 transmits the electrical signal to the IC chip 17. Thus, the IC chip 17 can perform operations in accordance with the electrical signal and function properly.

The receiving unit 181 is a part of the IC chip 18. In this case, when the optical modulation signal output from the emitting unit 13 is reflected or scattered by the optical surface 111 and then arrives at the receiving unit 181, the receiving unit 181 receives the optical modulation signal, converts it into an electrical signal and transmits the electrical signal to the other part of the IC chip 18. Thus, the IC chip 18 can perform operations in accordance with the electrical signal and function properly.

Moreover, the emitting unit 13 can signally connect to another IC chip (not shown), which outputs another electrical signal to the emitting unit 13. In this case, the emitting unit 13 can emit an optical modulation signal according to this electrical signal. Similarly, the emitting unit 13 can also be a part of another IC chip (not shown).

In the invention, the transmission medium 113 is a transparent bulk material such as a glass substrate. The emitting unit 13 and receiving unit 15 are optoelectronic semiconductor devices, and are provided on the transmission medium 113 by way of flip-chip attachment. Additionally, the IC chip 18 is also set on the transmission medium 113 by way of flip-chip attachment for enabling the transmission of optical modulation signals between the emitting unit 13, receiving unit 15, IC chip 18 and transmission medium 113. The optical surface 111 can be a reflecting film, scattering film or refracting film mounted on the surface of the transmission medium 113.

People skilled in the art should know that the electric apparatus of the invention might be a computer, an electric communicating device, an electric measuring instrument, or an information appliance.

In summary, since the electric apparatus of the invention employs air or a transparent bulk material provided inside the casing as a transmission medium of optical modulation signals, instead of optical fiber, the optical modulation signals can be transmitted from a single node to multiple nodes or from multiple nodes to a single node inside the electric apparatus of the invention. In the invention, a splitter, a demultiplexer, a combiner and a multiplexer are unnecessary. Furthermore, the optical modulation signal is transmitted via the transmission medium, which is air or a transparent bulk material contained inside the casing, so a connector is unnecessary. Thus, the manufacturing cost of the electric apparatus of the invention is reduced.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electric apparatus, comprising:
a casing, which has an optical surface inside;
an emitting unit, which is provided in the casing for emitting an optical modulation signal; and
a receiving unit, which is provided in the casing, the optical modulation signal traveling through the optical surface and being input to the receiving unit.

2. The electric apparatus of claim 1, wherein the optical surface is a reflecting surface.

3. The electric apparatus of claim 1, wherein the optical surface is a scattering surface.

4. The electric apparatus of claim 1, wherein the optical surface is a refracting surface.

5. The electric apparatus of claim 1, wherein the optical surface is mounted on an inner surface of the casing.

6. The electric apparatus of claim 1, further comprising:
a circuit substrate, which is provided in the casing, wherein the optical surface is mounted on the circuit substrate.

7. The electric apparatus of claim 1, wherein the receiving unit comprises a photo diode for receiving the optical modulation signal.

8. The electric apparatus of claim 7, wherein the receiving unit further comprises an optical filter for filtering the optical modulation signal to retrieve the optical modulation signal of a specific-wavelength, and the photo diode for receiving the optical modulation signal of the specific-wavelength.

9. The electric apparatus of claim 8, further comprising:
an additional receiving unit, which comprises an additional photo diode and an additional optical filter, the additional optical filter filters the optical modulation signal to retrieve an additional optical modulation signal of an additional specific-wavelength, and the additional photo diode receiving the additional optical modulation signal of the additional specific-wavelength.

10. The electric apparatus of claim 1, wherein the casing is filled with air, which is a transmission medium of the optical modulation signal.

11. The electric apparatus of claim 1, wherein a transparent bulk material being employed as a transmission medium of the optical modulation signal is provided inside the casing.

12. The electric apparatus of claim 11, wherein the transparent material is glass, and the receiving unit is set on the transparent material by way of flip-chip attachment.

13. The electric apparatus of claim 11, wherein the transparent material is glass, and the emitting unit is set on the transparent material by way of flip-chip attachment.

14. The electric apparatus of claim 1, which is a computer.

15. The electric apparatus of claim 1, which is an electric communicating device.

16. The electric apparatus of claim 1, which is an electric measuring instrument.

17. The electric apparatus of claim 1, which is an information appliance.
